(19) United States
(12) Patent Application Publication
(10) Pub. No.: US 2023/0242425 A1
(43) Pub. Date: Aug. 3, 2023

(54) NOVEL SLOW DISSOLVE WATER TREATMENT COMPOSITIONS

(71) Applicant: INNOVATIVE WATER CARE, LLC, Alpharetta, GA (US)

(72) Inventors: Touraj Rowhani, Alpharetta, GA (US); Ellen M. Meyer, Cleveland, TN (US); Michael Robbins, Paoli, PA (US); Karllee R. Barton, Chattanooga, TN (US)

(73) Assignee: INNOVATIVE WATER CARE, LLC, Alpharetta, GA (US)

(21) Appl. No.: 18/160,452

(22) Filed: Jan. 27, 2023

Related U.S. Application Data
(60) Provisional application No. 63/304,293, filed on Jan. 28, 2022.

(51) Int. Cl. C02F 1/68

(52) U.S. Cl. CPC C02F 1/688; C02F 2103/42

(57) ABSTRACT

The present invention provides calcium hypochlorite compositions that dissolve in approximately one week, while displaying both favorable reactivity properties and dissolution characteristics for recreation water treatment. The present invention benefits from the discovery that the dissolution profile of calcium hypochlorite compositions can be altered by providing compositions within a critical density range, for example when provided in the form of a tablet.

### CROSS-REFERENCE TO RELATED APPLICATIONS

This application claims the benefit of U.S. Provisional Application No. 63/304,293, filed Jan. 28, 2022.

### FIELD OF THE INVENTION

The present invention relates to water treatment tablets.

### BACKGROUND

Calcium hypochlorite is known for use as a disinfecting treatment for water. Calcium hypochlorite has been used as a disinfectant for potable water and recreational water including, but not limited to, pools, spas, hot tubs, and the like, and industrial water. Calcium hypochlorite serves as a source of chlorine in bodies of water, which acts as a disinfectant to keep water free of water-borne pathogens and other organisms such as algae. For example, calcium hypochlorite compositions are found in U.S. Pat. Nos. 3,793,216; 4,201,756; 4,145,306; 4,692,335; 5,164,109; and 5,753,602. In particular, U.S. Pat. Nos. 6,638,446 and 6,984,398 disclose compositions for treatment of recreational water that comprise mixtures of calcium hypochlorite and magnesium sulfate heptahydrate. U.S. Pat. No. 6,969,527 discloses compositions for treatment of recreational water that comprise mixtures of calcium hypochlorite, magnesium sulfate heptahydrate, and lime.

However, calcium hypochlorite compositions are known to quickly dissolve in water, especially in their granular form. As a result, calcium hypochlorite has been limited in its use in recreational water as a pool shock agent, to immediately increase the chlorine content in a pool. This is because longer-term water treatment agents should ideally last about one week in recreational pools before they dissolve. As a result, the chlorine found in commercially sold tablets is frequently in the form of trichlor (Trichloro-S-Triazinetrione). Trichlor reacts and dissolves slowly in the water to be treated, but as the trichloroisocyanuric acid reacts with the water to release chlorine, the trichloroisocyanuric acid also releases cyanuric acid as a by-product. Cyanuric acid is stable in water and the use of trichlor results in concentration of the acid increasing in pool water over time. At high cyanuric acid concentrations, normal chlorine levels can be rendered ineffective against water-borne pathogens. As a result, the level of the cyanuric acid in the pool will need to be decreased. This often requires either dilution by draining and refilling the pool with fresh water. Alternatively, another method commonly used is to add abnormally high doses of chlorine to overcome the effect of the cyanuric acid. This leads to pool water that is often unpleasant to the users of the pool.

Efforts to increase the dissolution time of calcium hypochlorite to serve as a longer-term agent have been limited. For example, U.S. Pub. No. 2016-0330972 describes experimental efforts to increase the dissolution time of calcium hypochlorite compositions to greater than one week by using greater than 20% total lime by weight in the exemplified compositions. However, calcium hypochlorite compositions with high levels of lime can lead to poor delivery of the calcium hypochlorite and the release of excessive dust into the water to be treated. Moreover, high levels of lime in calcium hypochlorite compositions results in compositions with a low total water content. Calcium hypochlorite with low water content is associated with increased reactivity and increased ability to accelerate combustion of fuel. Highly reactive compositions are both difficult to transport and store. U.S. Pub. No. 2021-0094848 describes experimental efforts to increase the dissolution time of calcium hypochlorite in compositions comprising both lime and magnesium sulfate. Nevertheless, the exemplified compositions described in U.S. Pub. No. 2021-0094848 dissolve within 5 days, shorter than the ideal period for a recreational pool cleaner.

### SUMMARY OF THE INVENTION

The present invention provides calcium hypochlorite tablet compositions that dissolve in approximately one week, while displaying both favorable reactivity properties and dissolution characteristics for recreation water treatment. The present invention benefits from the discovery that the dissolution profile of calcium hypochlorite tablet compositions can be dramatically modulated by providing compositions within a critical density range, for example when provided in the form of a tablet. With this insight, the present invention provides water treatment compositions that dissolve in approximately one week, but do not rely on lime content to decrease the dissolution rate of calcium hypochlorite tablets. As a result, the compositions of the invention are also able to provide a critical range of lime that provides dissolution stability without creating dust levels that would be unsuitable for recreational water bodies or increasing the hazard for storage and shipping.

Aspects of the invention provide a water treatment tablet comprising calcium hypochlorite, magnesium sulfate, and lime. Advantageously, the tablets have a density in a critical range from about 1.75 g/ml to about 1.85 g/ml. As a result, the tablets comprise total lime in the range from about 12% to about 19.0% based on the total weight of the tablet (e.g., 10% added lime). This lime range advantageously provides the tablet with favorable dissolution properties, for example being able to retain tablet shape during dissolution, without producing intolerable dust.

Moreover, the tablets may comprise a water content from about 10% to about 29.0% of the total weight of the composition. Advantageously, this water content allows for a favorable hazard profile for the compositions of the invention. For example, the compositions of the invention may be favorably designated as non-Division 5.1 oxidizing solids. The composition may comprise hydrated magnesium sulfate, which contributes to the water content of the composition. In aspects of the invention, the tablet may comprise from about 16% to about 29% hydrated magnesium sulfate.

The tablet may comprise a unitary structure. For example, the tablet may have a spherical or cylindrical shape, for example a puck-like shape. However, it is understood that the structure of the tablet may benefit from any shape which provides an even surface area for dissolution of the tablet while retaining a consistent shape and release of the composition over time.

Tablets with the critical density described can be designed for any water body based on size and flow rate. For example, the total weight of the tablet may be greater than 200 g to treat typical recreational pools, for example, a pool containing greater than 10,000 gallons of water. It is understood that tablet sizes may be adjusted based on the gallon content, flow rate, and temperature of a pool. For example, typical recreational pools comprise about 2,500, 5,000, 7,500, 10,000, 15,000; 20,000; 25,000; 30,000; 35,000; 40,000; 50,000; or greater than 50,000 gallons of water. Accordingly, the tablet may have a total mass from about 200 g to about 500 g for the treatment of recreational pools. Advantageously, because a critical feature of the tablets is their density, the mass of the tablets are scalable based on the water body to be treated. As a result, the tablets may be designed to be any size needed to dissolve in approximately one week, for example from 7 days to 9 days from being provided to the water body.

The tablets may also advantageously be designed based on the flow and temperature properties of the body of water to be treated. Both flow rate and temperature alters the rate at which a calcium hypochlorite tablet dissolves over time. Recreational pool conditions may consist of a flow rate of about 0.5% of the total volume of the water and/or a temperature from about 23.8 to about 37.8° C. For example, a 10,000-gallon pool may have a flow rate of 40 gallons per minute.

These conditions vary for different water body conditions, for example spa conditions, where temperatures and flow rates may be increased while water volumes may be reduced. Tablet mass may similarly be varies based on these conditions, while maintaining a critical density for the tablet.

Aspects of the invention also provide methods of treating water. The invention provides methods comprising placing in a body of water a tablet. The tablet may comprise calcium hypochlorite and lime an amount which results in the tablet having a total lime content from about 10% to about 19.0% of the total weight of the tablet. Advantageously, the density of the tablet is in the critical range from about 1.75 g/ml to about 1.85 g/ml. The methods further comprise the step of dissolving to completion the tablet in the body of water over a period of from 7 and 9 days.

As described above, the tablet may comprise a total water content from about 12.0% to about 29.0% of the total weight of the composition. The tablet may comprise hydrated magnesium sulfate. The tablet may comprise from about 16% to about 29% hydrated magnesium sulfate.

The tablet may have a cylindrical shape. The total weight of the tablet may be from about 200 g to about 500 g. The body of water being treated may be a recreational pool. The dissolving step may comprise maintaining a flow rate of about 0.5% of the total volume of the body of water. The dissolving step may comprise maintaining a temperature for the body of water from about 23.8 to about 37.8° C. The placing step may comprise placing the tablet in the body of water in a floater, dispensing feeder or skimmer basket.

### BRIEF DESCRIPTION OF THE DRAWINGS

FIG. 1A and FIG. 1B depict the dissolution of a 37.8 mm tablet.

FIG. 2 depicts the dissolution of two 39.0 mm tablets.

FIG. 3 depicts the dissolution of two 40 mm tablets.

FIG. 4 depicts the dissolution of two 41 mm tablets.

FIG. 5A and FIG. 5B depict the dissolution of two 38 mm tablets.

FIG. 6 shows a table of the dissolution rate of two 37.8 mm tablets.

FIG. 7 shows a table of the dissolution rate of two 39.0 mm tablets.

FIG. 8 shows a table of the dissolution rate of two 40.0 mm tablets.

FIG. 9 shows a table of the dissolution rate of two 41.0 mm tablets.

FIG. 10 shows a table of the average dissolution rates of tablets with 5 different densities.

FIG. 11 shows a chart of the dissolution rate of tablets with 5 different densities.

FIG. 12 shows a chart of dissolution rate by tablet density.

### DETAILED DESCRIPTION

The present invention provides calcium hypochlorite compositions that dissolve in approximately one week, while displaying both favorable reactivity properties and dissolution characteristics for recreation water treatment. The present invention benefits from the discovery that the dissolution profile of calcium hypochlorite compositions can be altered by providing compositions within a critical density range, for example when provided in the form of a tablet.

Aspects of the invention provide a water treatment tablet comprising calcium hypochlorite and lime. Advantageously, the tablets have a density in a critical range from about 1.75 g/ml to about 1.85 g/ml. In aspects of the invention, the density of the tablet may be lowered along with a corresponding change to the composition, for example an increase in the content of lime. For example, the density As a result, the tablets comprise lime in the range from about 12.0% to about 19.0% based on the total weight of the tablet. This lime range advantageously provides the tablet with favorable dissolution properties, for example being able to retain tablet shape during dissolution, without producing intolerable dust.

Compositions

The calcium hypochlorite to be used in the tablets of the invention can be either anhydrous or hydrated. Anhydrous calcium hypochlorite, which is commercially available, should contain at least about 60% by weight of Ca(OCl)₂. For example, compositions may comprise approximately 60%, 65%, or 70% calcium hypochlorite. Hydrated calcium hypochlorite should contain at least about 50% by weight of Ca(OCl)₂ and have a hydrated water content ranging from about 4 to about 25% by weight, based on the weight of the calcium hypochlorite. Hydrated calcium hypochlorite can be prepared by the methods described, in U.S. Pat. Nos. 3,544,267 and 3,669,984, both of which incorporated by reference in their entireties. Generally, commercially available calcium hypochlorite compositions contain 50-95% by weight calcium hypochlorite and other components, other than water of hydration, such as salts (sodium chloride, calcium chloride, calcium carbonate, and the like) in amounts up to 20% by weight. However, it is desirable to keep these other components to a minimum. The process used to make calcium hypochlorite may also result in lime being present in the calcium hypochlorite in amounts up to about 2-4% by weight, based on the weight of the calcium hypochlorite composition. Hydrated means a component with a water content of at least 4% by weight.

Advantageously, tablets of the invention maintain their structural integrity as they dissolve. This means that the tablets remain intact, essentially retaining their general shape and hardness while dissolving. For example, the tablets may remain hard, and retain their overall structure when placed in water, but reduce in size due to dissolution.

Lime may be calcium oxide or calcium hydroxide. Lime in the present invention is preferably the inactive form calcium hydroxide (Ca(OH)₂). The lime is blended with the calcium hypochlorite in an amount such that the resulting composition contain 10-19% by weight, based on the total weight of the tablet. As is noted above, lime may also be present in calcium hypochlorite in amounts of about 1-4% by weight, depending on the manufacturing process used to manufacture the calcium hypochlorite. In any event, if lime is present in the calcium hypochlorite used to make the composition, the lime content of the calcium hypochlorite is accounted for in the total lime content in the composition. For example, if the calcium hypochlorite contains 3% by weight lime, and 10% by weight lime is added to the calcium hypochlorite, the resulting blend will contain 12.7% by weight lime. (90% x3% (lime in Ca(OCl)₂)+10% lime=12.7%).

Magnesium sulfate has the general formula of (MgSO₄·2H₂O), where x is the number of moles of hydrated water. Examples of hydrated forms include magnesium sulfate monohydrate, magnesium sulfate dihydrate, magnesium sulfate trihydrate, magnesium sulfate tetrahydrate, magnesium sulfate pentahydrate, magnesium sulfate hexahydrate, and magnesium sulfate heptahydrate, or mixtures thereof.

Depending on the configuration of the tablets, different processes are used to form the tablets. The tablet may be formed from the blend of calcium hypochlorite, lime, and/or hydrated magnesium sulfate and may be prepared from granular blends of the compounds. The composition may be blended using any known techniques. For example, tumble blenders, V-blenders, ribbon blenders and the like may be used in a batch mode to blend the compositions. Additionally, screw augurs, conveyers, and the like may be used in a continuous mode to blend the composition. An alternative method is to the compounds in a wet state and then drying the resulting mixture. Critically, the process should result in a composition with a density within the critical range to provide a favorable dissolution profile.

Any conventional tableting process and equipment normally used for making calcium hypochlorite containing tablets may be used to manufacture the tablets of the present invention. Any suitable equipment that produces molded compacted products such as tablets, caplets or briquettes, or other known molded compacted products, using the blends of the present invention may be used.

Although tablets are particularly suitable for the density profiles of the invention, any shape or size tablet may be used. Preferred shaping equipment includes hydraulic tableting presses (such as Hydratron or Hydramet or Bipel hydraulic presses), briquetting apparatus (such as a Bepex Compactor), and the like. Any suitable dwell times and pressures may be used in operating such hydraulic presses. Specifically, these tablets are useful as water treatment sanitizers (e.g., in reactional swimming pools and spas), and are especially safer to transport and store than calcium hypochlorite itself.

Advantageously, a piston may be used to shape the tablet and impart a particular thickness in mm and density to the tablet. For example, the piston stroke length may be used to set a mm thickness for a given mass for the tablet, resulting in a density from about 1.75 to about 1.85 g/ml. For example, tablets may be formed using a hydraulic press with a set force and dwell time, for example presses as sold by Carver, Inc. (Wabash, Ind.) or Baldwin Technology Company, Inc. (St. Louis, Mo.). A person of skill in the art will appreciate how to adjust a press to produce a tablet with a desired thickness and density.

Hazard Properties

Calcium hypochlorite is a strong oxidizer and as such can cause a severe increase in the burning rate of combustible material with which it comes in contact. This oxidation characteristic can cause problems both in the transport and storage of the product. For example, fires involving calcium hypochlorite can be quite vigorous, particularly when combustible material is present, including the product's packaging material itself (e.g., plastic, cardboard).

A non-Division 5.1 oxidizer is a composition or compound that is not rated as a Division 5.1 oxidizer as measured by an internationally recognized standard, i.e., the United Nations Protocol: Transport of Dangerous Goods: Manual of Tests and Criteria, Section 34; Classification Procedures, Test Methods, and Criteria relating to Oxidizing Substances of Division 5.1.

Classification of oxidizers is also given by the National Fire Protection Association (NFPA). The definition of an oxidizer is given as any material that readily yields oxygen or other oxidizing gas, or that readily reacts to promote or initiate combustion of combustible materials and can undergo a vigorous self-sustained decomposition due to contamination or heat exposure. Oxidizers are further broken down according to the degree to which they increase the burning rate of combustible materials as follows:

Class 1: An oxidizer that does not moderately increase the burning rate of combustible materials with which it comes into contact.

Class 2: An oxidizer that causes a moderate increase in the burning rate of combustible materials with which it comes into contact.

Class 3: An oxidizer that causes a severe increase in the burning rate of combustible materials with which it comes into contact.

Class 4: An oxidizer that can undergo an explosive reaction due to contamination or exposure to thermal or physical shock and that causes a severe increase in the burning rate of combustible materials with which it comes into contact.

Calcium hypochlorite is a Class 3 oxidizer according to the NFPA oxidizer classification system.

Efforts have been made to produce hydrated calcium hypochlorite containing products that are not classified as a Division-5.1 oxidizer and are classified as a Class 1 NFPA oxidizer. The present invention benefits from the discovery that density may be used to form tablets with ideal calcium hypochlorite dissolution times. As a consequence, lime content in the composition may be adjusted to allow for additional total water content in the composition. This additional water content provides favorable reactivity properties, for example classification as a non-Division 5.1 oxidizer.

Hydrated magnesium sulfate may be used to contribute total water to the composition. The lower the degree of hydration of the magnesium sulfate, the greater amount of the hydrated magnesium sulfate will need to be added. Typically, magnesium sulfate tetrahydrate, magnesium sulfate pentahydrate, magnesium sulfate hexahydrate and/or magnesium sulfate heptahydrate are used for their great water content due to water of hydration. For example, a monohydrate will need to be present in a greater amount than a hydrate having more waters of hydration, since the monohydrate contains less water than, for example, heptahydrate.

Moreover, magnesium sulfate may also directly influence the dissolution rate of the tablet. Without being limited to a mechanism of action, the sulfate in magnesium sulfates may create slow dissolving calcium sulfate, which further reduces the dissolution rate of the tablets.

Advantageously, the calcium hypochlorite compositions of the invention may comprise a critical total water content range of from about 12.0% to about 29.0% of the total weight of the composition, which allows for the compositions to be classified as a non-Division-5.1 oxidizer and as a Class 1 NFPA oxidizer.

### EXPERIMENTAL EXAMPLES

### Example 1: Critical Density

Calcium hypochlorite compositions comprising 71.2% calcium hypochlorite, 16.4% magnesium sulfate, and 12.3% total lime were prepared. The calcium hypochlorite used in the compositions had a 48.4% available chlorine content.

Four sets of tablets were prepared from the composition, each set approximately 256 g in mass. Each set of tablets was pressed to a fixed depth/thickness, respectively 37.8 mm, 39 mm, 40 mm, and 41 mm, giving the set of tablets the densities indicated below:

| Tablet density (g/ml) | Tablet thickness (mm) |
|---|---|
| 1.89 | 37.8 |
| 1.84 | 39 |
| 1.79 | 40 |
| 1.75 | 41 |

A control tablet sold under the trade name HTH BLUE SPARKLE, manufactured by Innovative Water Care, LLC (Georgia), was used, which had a density of 1.88 g/ml and a tablet thickness of 38 mm.

Two tablets from each set were placed in a pool skimmer and placed in a water body replicating recreational pool conditions. Specifically, each skimmer was placed in an in-ground 10,000-gallon pool with a pump run time of 8 hours and flow rate of 40-45 gallons per minute. The water was maintained at a temperature of 80-83° C.

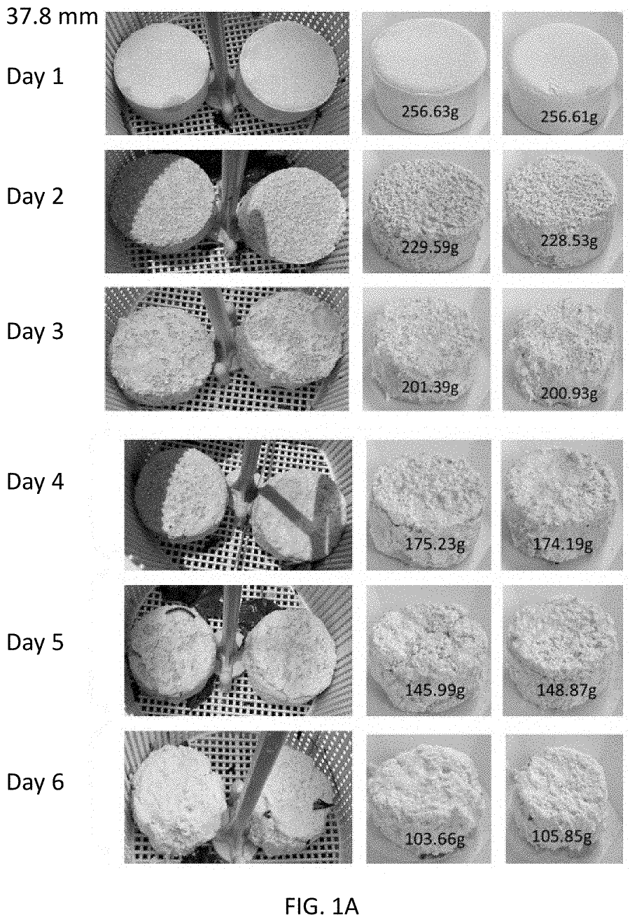

FIG. 1A and FIG. 1B depict the dissolution of the 37.8 mm tablets with a density of 1.89 g/ml. Both tablets took greater than 11 days to dissolve. Average free available chlorine levels in the pool were 1.21 ppm.

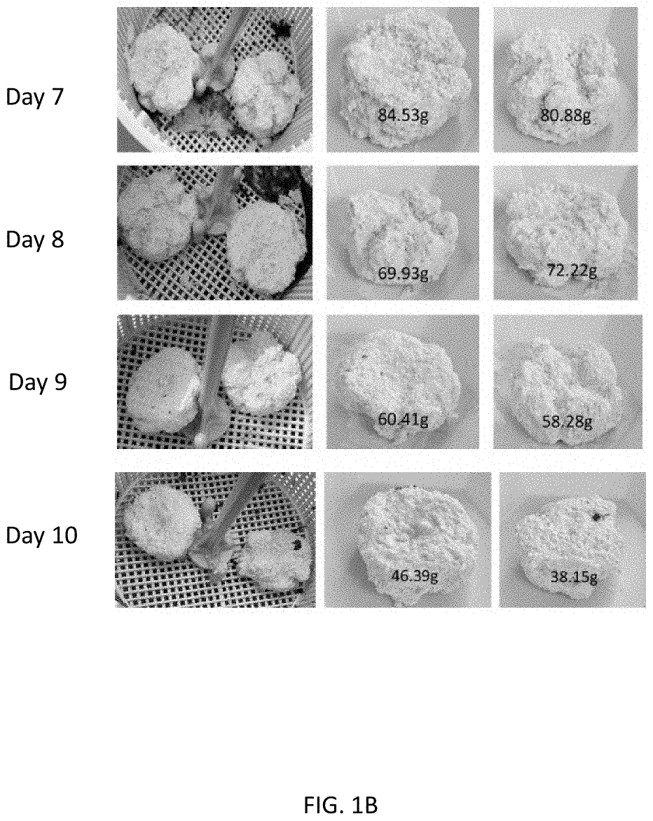

FIG. 2 depicts the dissolution of the 39.0 mm tablets with a density of 1.84 g/ml. Both tablets took 8 days to dissolve.

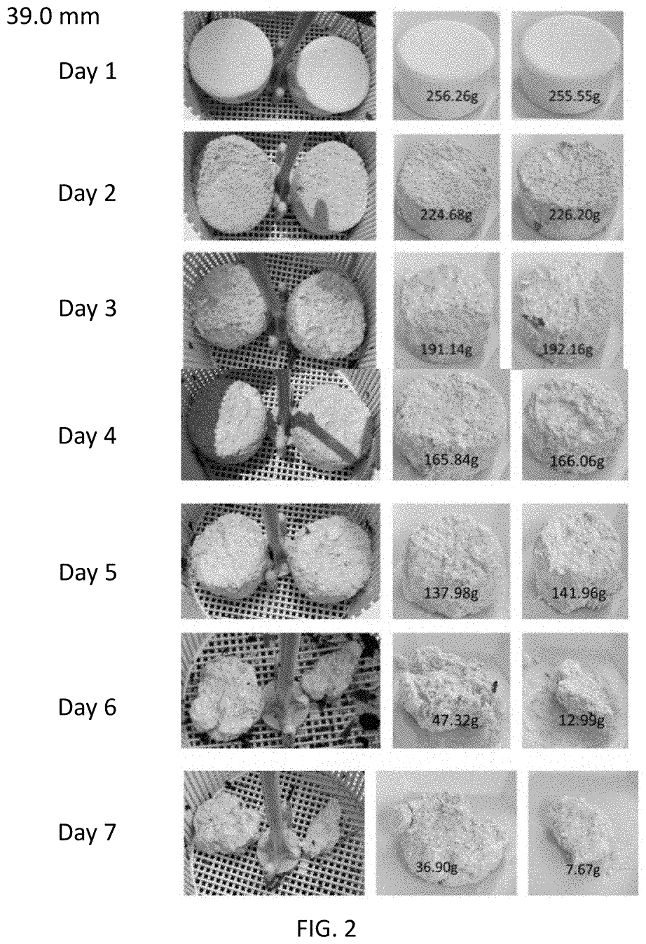

FIG. 3 depicts the dissolution of the 40 mm tablets with a density of 1.79 g/ml. Both tablets took 7 days to dissolve.

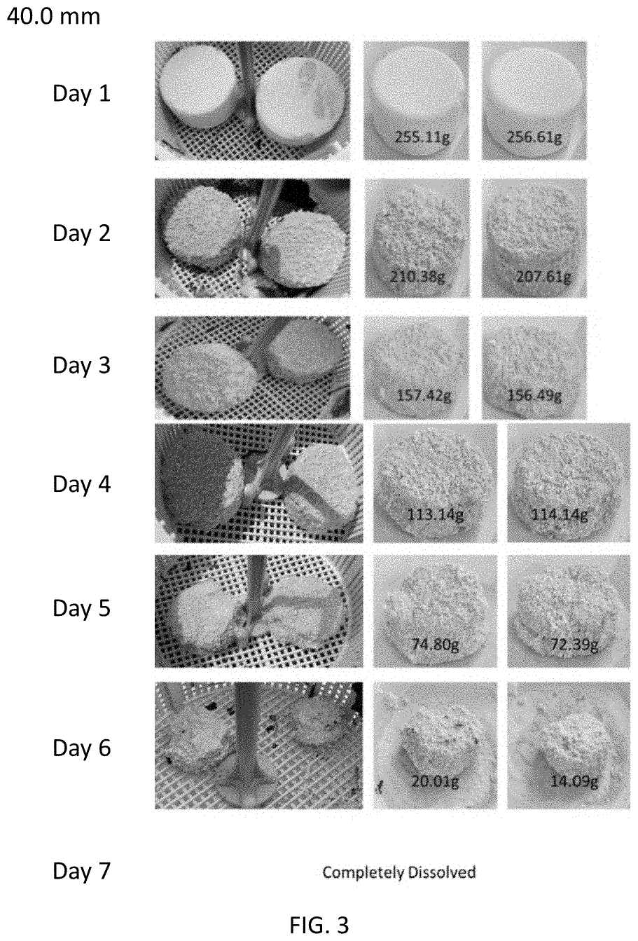

FIG. 4 depicts the dissolution of the 41 mm tablets with a density of 1.75 g/ml. Both tablets took 8 days to dissolve.

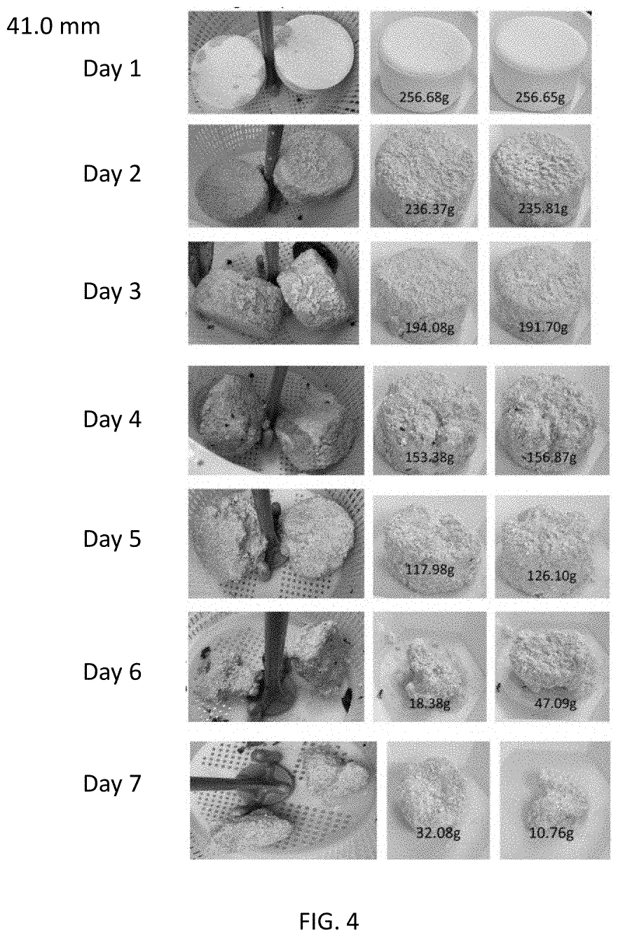

FIG. 5A and FIG. 5B depict the dissolution of the 38 mm control tablets with a density of 38 mm. Both tablets took greater than 11 days to dissolve.

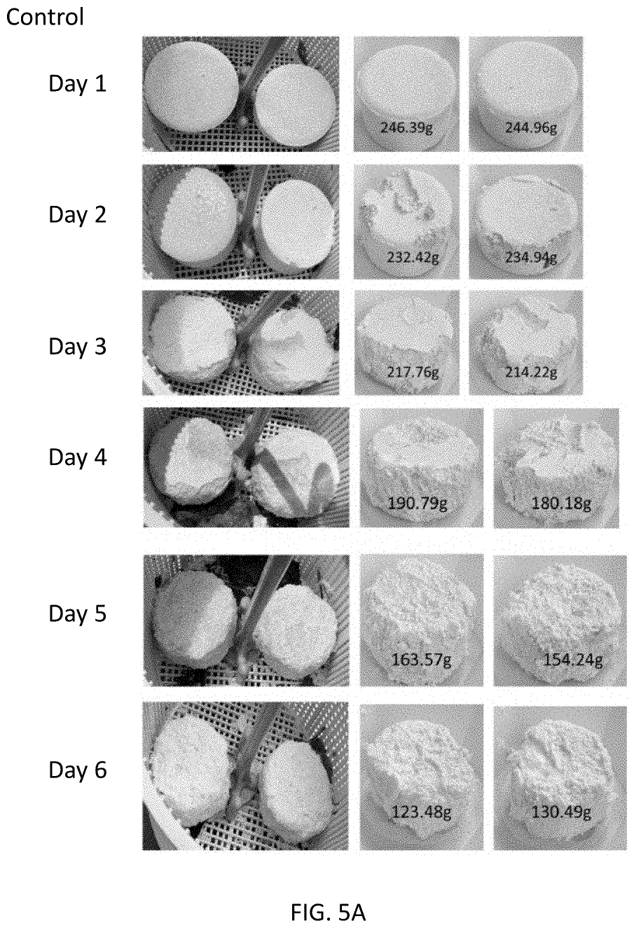

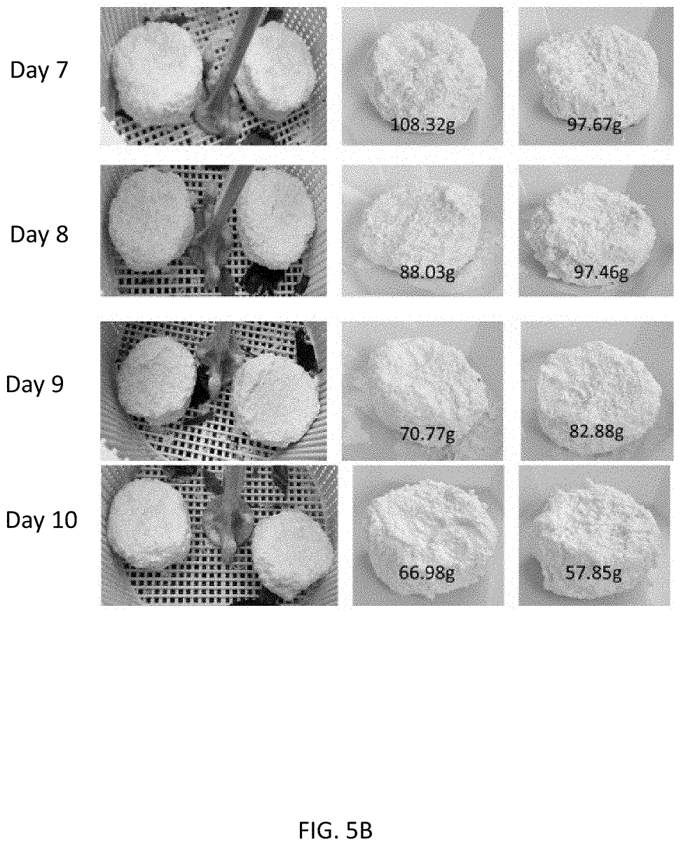

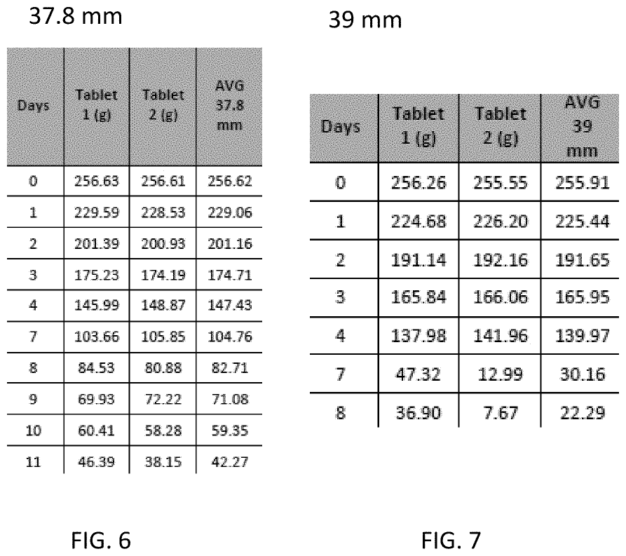

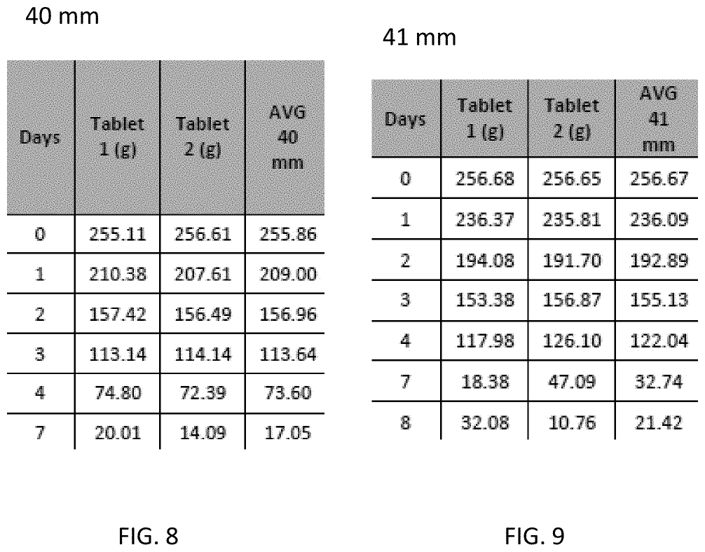

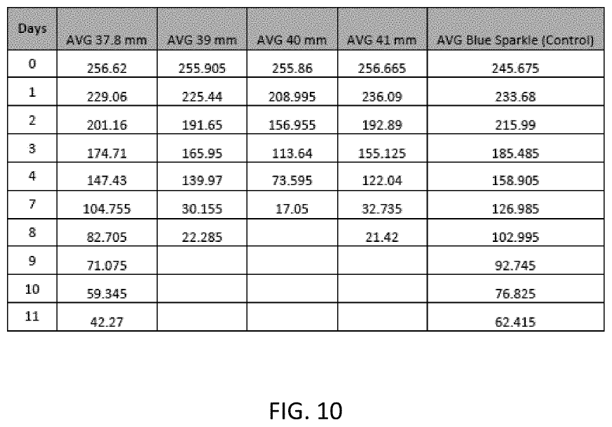

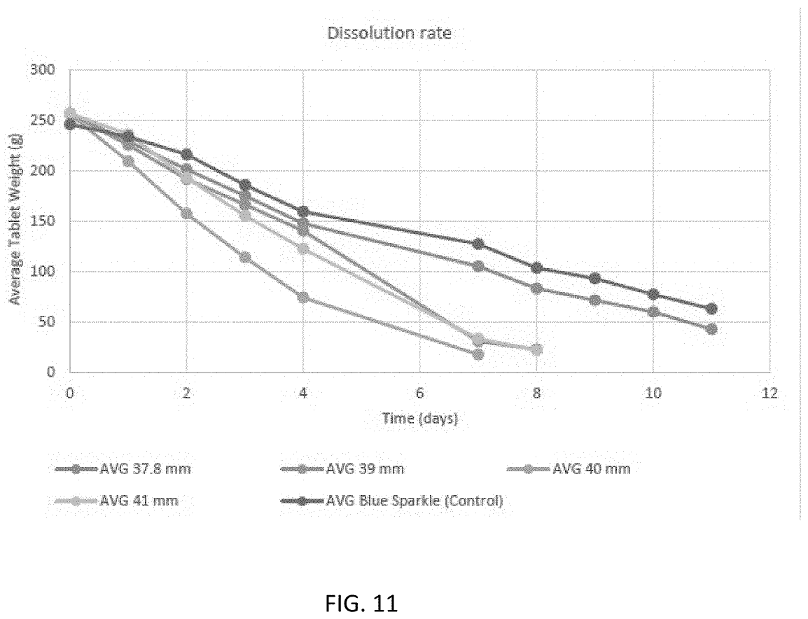

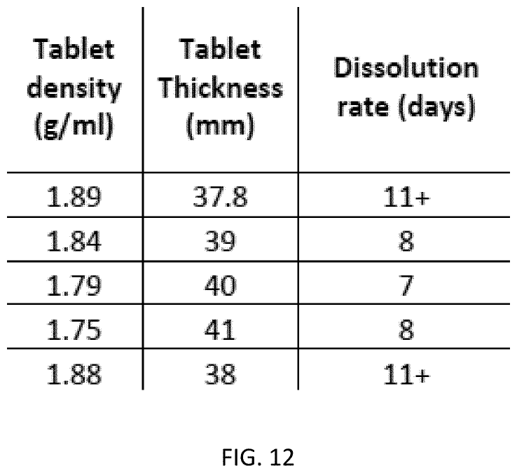

FIG. 6-12 provide summarized tables and figures depicting the dissolution rates of each of the sets of tablets.

### Example 1: Discussion

Surprisingly, it was discovered that tablets with a density of 1.75, 1.79, and 1.84 each dissolved within the ideal period for a recreational pool cleaner of 8, 7, and 8 days respectively. Increasing the density of the tablet to 1.88 or 1.89 g/ml resulted in a dramatic decrease in the dissolution rate of the tablets, outside of the ideal range for pool cleaners.

The criticality of this density range is further highlighted by contrast with the experimental examples of 2021-0094848. As shown in Example 2 of US 2021-0094848, tablets comprising 68% calcium hypochlorite, 13% total lime, and 22% magnesium sulfate were tested for their dissolution properties in a 5000-gallon pool run for 8 hours per day. Each tablet had a density of 1.65, outside of the critical range discovered by the present invention. As a consequence, each tablet dissolved within 5 days, despite the tablets being described as “slow dissolving” and despite the composition of the tablet itself.

### Example 2: Oxidizer Rating

A calcium hypochlorite composition comprising 90.9% calcium hypochlorite and 9% lime was tested to determine the composition's oxidizer rating. The calcium hypochlorite comprised 11.28% water, resulting in a composition having 10.25% water by weight.

The tests were conducted to accommodate both the NFPA and O.3 burn testing protocols. The NFPA method may be found in NFPA 400 Hazardous Materials Code 2016 Edition, Annex G. The 0.3 method may be found in the Recommendations on the Transport of Dangerous Goods, Manual of Tests and Criteria, Fifth Revised Edition, Amendment 2, United Nations, 2013 (ST/SG/AC.10/11/Rev.5/Amend.2), 34.4.3 Test O.3: Gravimetric test for oxidizing solids, each of which is herein incorporated by reference in their entirety herein.

The NFPA and O.3 burning protocols require that the oxidizer be mixed with cellulose powder and the mixture is ignited with a hot wire. The burning rate of the mixture is measured using weight loss, and is used to determine the classification. The calcium hypochlorite composition was determined to be a Division 5.1 oxidizer and NFPA Class 2 compound.

Further tests were conducted on two compositions, each comprising approximately 75% calcium hypochlorite, 14% magnesium sulfate heptahydrate, and the first composition comprising 10.00% lime and the second composition comprising 12.30% lime. Each final composition contained a total water content of approximately 12.00% by weight of the composition.

Both compositions displayed a burn rate of 0.18 g/s, meeting the definitions of a non 5.1 oxidizing solid according to the 0.3 test. These results showed the criticality of 12% water content for calcium hypochlorite compositions in order to achieve a non-5.1 oxidizing solid rating.

### Example 2: Discussion

Advantageously, compositions of the invention benefit from the discovery that critical densities of calcium hypochlorite tablets may be used to achieve favorable dissolution rates for the tablets. Accordingly, the tablets achieve a dissolution rate of approximately one week without the inclusion of amounts of lime which lower the water content of the compositions below 12%. Accordingly, compositions of the invention may favorably be formulated to be considered non-oxidizing solids.

1. A water treatment tablet comprising:
calcium hypochlorite;
lime, in an amount which results in the tablet having a total lime content from about 10.0% to about 19.0% of the total weight of the tablet,
wherein the density of the tablet is from about 1.75 g/ml to about 1.85 g/ml.

2. The tablet of claim 1, wherein the tablet comprises a total water content from about 12.0% to about 29.0% of the total weight of the composition and wherein the composition is not a Division 5.1 oxidizing solid.

3. The water treatment tablet of claim 2, wherein the tablet comprises hydrated magnesium sulfate.

4. The water treatment tablet of claim 3, wherein the tablet comprises from about 17% to about 29% hydrated magnesium sulfate.

5. The water treatment tablet of claim 1, wherein the tablet has a cylindrical shape.

6. The water treatment tablet of claim 5, wherein the total weight of the tablet is greater than 200 g.

7. The water treatment tablet of claim 6, wherein the total weight of the tablet is from about 200 g to about 500 g.

8. The water treatment tablet of claim 7, wherein when placed in recreational pool water conditions, the tablet completely dissolves from 7 days to 9 days.

9. The water treatment tablet of claim 8, wherein the recreational pool water conditions comprise a flow rate of about 0.5% of the total volume of the water.

10. The water treatment tablet of claim 9, wherein the pool water conditions comprise a temperature of from about 23.8 to about 37.8° C.

11. A method of treating water, the method comprising:
placing in a body of water a tablet comprising:
calcium hypochlorite;
lime, in an amount which results in the tablet having a total lime content from about 10.0% to about 19.0% of the total weight of the tablet, and
wherein the density of the tablet is from about 1.75 g/ml to about 1.85 g/ml, and
dissolving to completion the tablet in the body of water over a period of from 7 to 9 days.

12. The method of claim 11, wherein the tablet comprises a total water content from about 12.0% to about 29.0% of the total weight of the composition.

13. The method of claim 11, wherein the tablet comprises hydrated magnesium sulfate.

14. The method of claim 12, wherein the tablet comprises from about 16% to about 29% hydrated magnesium sulfate.

15. The method of claim 11, wherein the tablet has a cylindrical shape.

16. The method of claim 15, wherein the total weight of the tablet is from about 200 g to about 500 g.

17. The method of claim 16, wherein the body of water is a recreational pool.

18. The method of claim 17, wherein the dissolving step comprises maintaining a flow rate of about 0.5% of the total volume of the body of water.

19. The method of claim 18, wherein the dissolving step comprises maintaining a temperature for the body of water from about 23.8 to about 37.8° C.

20. The method of claim 19, wherein the placing step comprises placing the tablet in the body of water in a floater, dispensing feeder, or skimmer basket.
